(19) United States
(12) Patent Application Publication
(10) Pub. No.: US 2013/0032079 A1
(43) Pub. Date: Feb. 7, 2013

(54) FASTENING SYSTEMS

(71) Applicants: Christopher E. Erdahl, Asheville, NC (US); Mark R. Robertson, Greenville, SC (US); Jeffery S. Stewart, Seneca, SC (US)

(72) Inventors: Christopher E. Erdahl, Asheville, NC (US); Mark R. Robertson, Greenville, SC (US); Jeffery S. Stewart, Seneca, SC (US)

(73) Assignee: CONFLUENCE HOLDINGS CORP., Easley, SC (US)

(21) Appl. No.: 13/566,974

(22) Filed: Aug. 3, 2012

Related U.S. Application Data
(60) Provisional application No. 61/514,865, filed on Aug. 3, 2011.

(51) Int. Cl. F16M 13/02; B63B 35/71; F16B 11/00

(52) U.S. Cl. 114/347; 403/267; 248/503

(57) ABSTRACT

Embodiments herein provide methods, apparatuses, and systems for fastening articles to an internal, or free form, surface of a rotomolded base. Inserts of various shapes and sizes may be incorporated/molded into a rotomolded base to provide a conventional primary attachment site on the exterior surface of the base. A portion of an insert that is molded into the base may project from the interior surface of the base. The projecting portion of the insert and the overlying rotomolded material may form a coupling element on the interior surface of the base, which may be used to attach an article to the interior surface.

### CROSS REFERENCE TO RELATED APPLICATION

The present application claims priority to U.S. Provisional Patent Application No. 61/514,865, filed Aug. 3, 2011, entitled “FASTENING SYSTEMS,” the entire disclosure of which is hereby incorporated by reference in its entirety.

### TECHNICAL FIELD

Embodiments herein relate to the field of mechanical fasteners, and, more specifically, to methods, systems, and apparatuses for fastening an object to a base article.

### BACKGROUND

Rotational molding, or “rotomolding,” is commonly used to construct hollow articles for use in industrial, agricultural, and commercial products. For example, kayak hulls are often constructed using this technique. Fastening other articles to a hollow rotomolded base generally requires drilling or piercing of the structure to insert a bolt, screw, or other fastener. However, piercing the base may weaken the structure and permit the entry of fluids. Alternatively, an insert may be included during the rotomolding process in order to provide an attachment site. The insert is typically open at one end, allowing a second article to be inserted into the opening and affixed to one surface of the base. However, attachment sites on the opposite surface of the base must be provided separately. This increases the complexity of the product's design and may also increase the cost due to the additional labor and materials required.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1a illustrates an article coupled to the exterior surface of a rotomolded base in accordance with various embodiments;

FIG. 1b illustrates the interior surface of the rotomolded base of FIG. 1a;

FIG. 2 illustrates examples of inserts that may be molded into a base;

FIGS. 3a-b illustrate examples of coupling elements on an interior surface of a base;

FIGS. 4a-d illustrate examples of insert and coupling element configurations;

FIGS. 5a-c illustrate an article configured to engage a coupling element;

FIG. 6 illustrates the article of FIGS. 5a-c in engagement with the coupling elements of FIG. 1b;

FIG. 7 illustrates the arrangement of FIG. 6 in engagement with an additional article; and

FIGS. 8a-e illustrate examples of articles coupled to a rotomolded base in various configurations by coupling elements, all in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or mechanical contact with each other. “Coupled” may mean that two or more elements are in direct physical or mechanical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

As used herein, the terms “internal” and “external” refer to surfaces of a rotomolded base. Specifically, in reference to a rotomolded base with an insert, an “external” surface of the base is a surface on which a first portion of the insert (e.g., an end, an edge, or an opening) is exposed. An “internal” surface of the base is a surface on which a second portion of the insert is covered by rotomolded material and not exposed. The covered second portion of the insert may form a shape (e.g., protrusion or invagination) on or in the interior surface. In some examples, the “internal” surface may be positioned within an interior portion of a product and the “exterior” surface may form part of the exterior surface of the product (e.g., the interior and exterior surfaces of the hull of a kayak). Alternatively, the “internal” surface may be positioned on the exterior of a product and the “exterior” surface may be positioned on the interior of a product, or both surfaces may be positioned within either the interior or exterior of the product. As another alternative, a rotomolded base may have two opposite “internal” surfaces (i.e., an insert protrudes from opposite surfaces with each end of the insert covered by rotomolded material).

As used herein, the terms “rotomolded base” and “base” refer to any article produced by a rotational molding (rotomolding) process. The term “base” refers to any article produced by a rotomolding process. Such bases may be constructed from a polymer, such as a plastic. Examples of plastics/polymers include, but are not limited to, thermoplastics, thermosetting plastics, polyethylene (e.g., cross-linked polyethylene, low density polyethylene, linear low-density polyethylene, linear medium-density polyethylene, high density polyethylene, high density polyethylene regrind), polyvinyl chloride (PVC), PVC plastisols, nylon, polypropylene, polycarbonate, aluminum, acrylonitrile butadiene styrene, acetal, acrylic, epoxy, polybutylene, polyester, polystyrene, polyurethane, and silicone.

Inserts of various shapes and sizes may be incorporated/molded into a rotomolded base (e.g., a boat hull, boat deck, accessory, or part) to provide a conventional attachment site on the exterior surface of the base. A portion of an insert that is molded into the base may project from the interior surface of the base, creating an “averaged” or more organic shape on the inside of the rotomolded base when the rotomolded material is molded around it. The projecting portion of the insert and the overlying rotomolded material may be used as an attachment site for various articles. The covered inserts may create positive locking points and/or undercuts for more aggressive attachment.

Embodiments herein provide methods, apparatuses, and systems for fastening articles to a rotomolded base. In particular, some embodiments provide systems and methods for fastening an article to an internal, or free form, surface of a rotomolded base. A rotomolded base may include an insert that is molded into the wall of the base. A first portion of the insert may be exposed on the exterior surface of the rotomolded base, and a second portion of the insert may protrude from the interior surface of the rotomolded base. The protruding second portion of the insert may be covered by the rotomolded material on the interior surface of the base. The protruding second portion and overlying rotomolded material may form a coupling element on the interior surface. The coupling element may provide an attachment site for an article, and may be used to attach the article to the interior surface of the rotomolded base.

Other embodiments provide articles configured to be retained by the coupling element. The articles may include one or more apertures and/or surface features configured to engage the coupling element. Some articles may be configured to allow repeated attachment to, and removal from, the coupling element with little to no wear on the article and the coupling element. Other articles may be configured to be permanently affixed to the base. In some examples, the article(s) may be configured to retain a second article, such as a structural component or an optional accessory, and may be used to couple the second article to the interior surface of the rotomolded base.

Therefore, the exposed portion of the insert may be used as a primary attachment point for attaching one or more items to the exterior surface of the base, and the coupling element formed by the insert and rotomolded material may form a secondary attachment point for attaching one or more articles to the interior surface of the base. Molding inserts into the base and using the exposed portion as a primary attachment point can reduce or eliminate holes in the base that would otherwise be required for attaching items/articles to the base, as well as reducing or eliminating access issues. Using the coupling elements as secondary attachment points may reduce or eliminate the need for extra fasteners and may reduce assembly costs.

The coupling elements may be used in a wide variety of applications. In some embodiments, the coupling elements may be provided in or on a rotomolded portion of a boat/watercraft. For example, one or more of the coupling elements may be provided on the rotomolded hull/deck of a kayak. The coupling elements may be used to attach any one or more other components to the hull/deck, such as a structural component (e.g., a bulkhead) or an accessory (e.g., a bag, a clip, a rope, a spray skirt, a storage compartment, a cockpit cover, a seat, a tie down area/mount, a paddle park/retainer, padding, an oar mount, rigging, a light, a pump, a float, a towline, a paddle leash/float, fishing gear, security cable, or hanger) or any portion thereof. Similarly, the coupling elements may be used to attach a mount for any such component or accessory to the hull/deck. Coupling elements may also be provided in seats and/or seating systems (e.g., for adjustment of seats, inserts in seats).

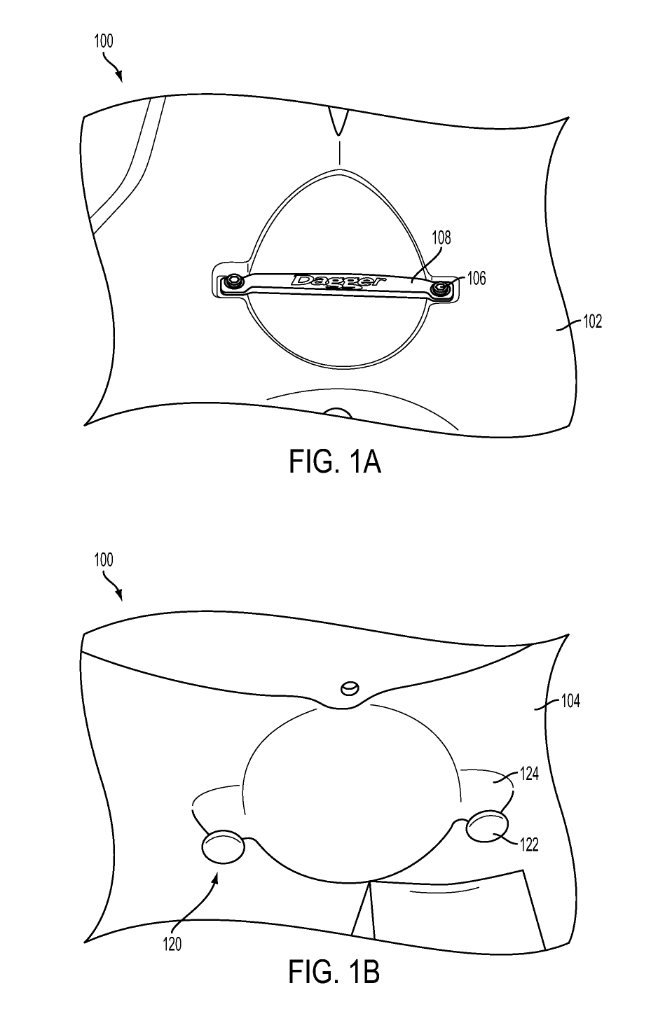

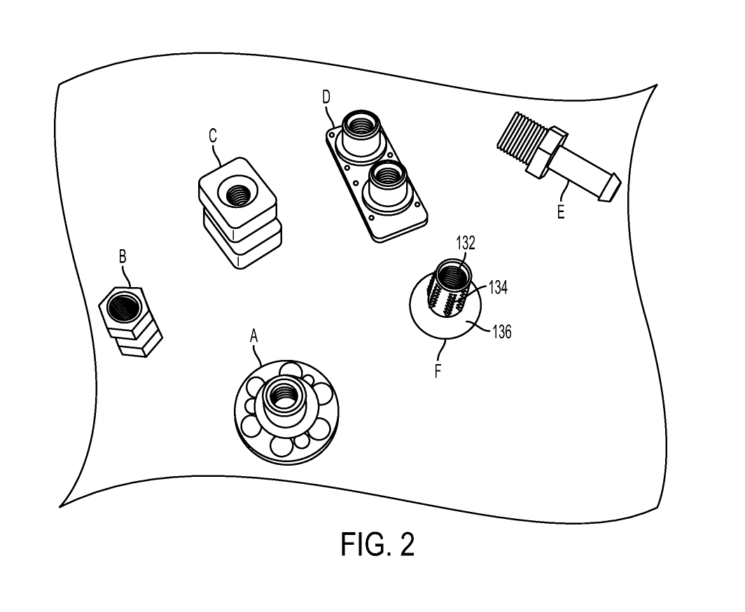

FIGS. 1a and 1b illustrate an exterior surface and an interior surface, respectively, of a rotomolded base. As shown in FIG. 1a, an article 108 may be attached to the exterior surface 102 of a rotomolded base 100 by one or more fasteners 106. In this example, the rotomolded base 100 is the hull or deck of a boat and the article 108 is a handle. The rotomolded base 100 includes two inserts (not shown; see FIG. 2) that are molded into the material of the base. In this example, the insert has a hollow interior fastener with a hole at one end. Examples of inserts with hollow interior fasteners and a hole at one or more ends are illustrated in FIGS. 2a-f (see e.g., FIG. 2e). The insert is molded into the base 100 with the hole (not shown) exposed on the exterior surface 102. The fasteners 106 are retained within the opening of the insert.

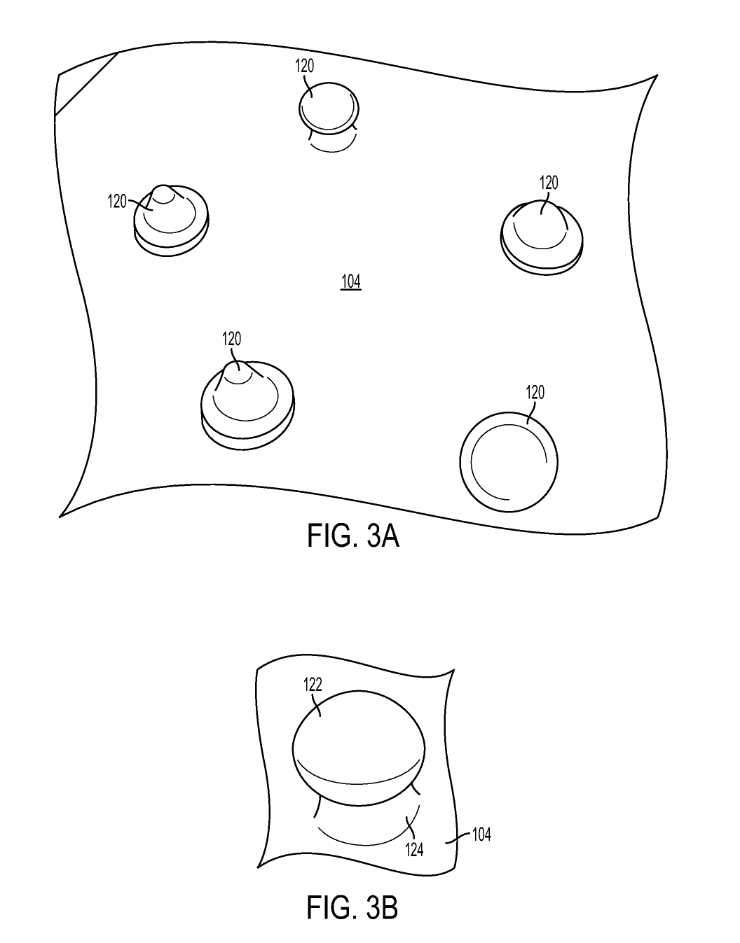

The second, opposite end of each insert protrudes from the interior surface of the base and is covered by the rotomolded material of the base 100 (FIG. 1b). The covered protrusions form coupling elements 120 on the interior surface 104 of the base 100. As illustrated, a coupling element 120 may have a base 124 and a terminal end 122, described further below with regard to FIGS. 3a and 3b.

A variety of inserts may be used to create attachment sites on the exterior and interior surfaces of a rotomolded base. FIG. 2 illustrates several examples of inserts that may be incorporated into a rotomolded base. Some inserts may have a threaded interior portion/opening. Other inserts may have a threaded exterior portion. Still other inserts may lack threads. Inserts may be solid, hollow, or partially hollow (e.g., a ‘blind’ insert with an open end and a closed end). An insert may include an internally threaded hollow rod/sleeve, a non-threaded hollow rod/sleeve, an externally threaded post, a non-threaded post, a flange or bushing, a nut, a bolt, or any other mechanical fastener or portion thereof. Examples of inserts include T-nuts, NPT inserts, SAE ports, and bulkhead fittings. An insert may comprise one or more metals (e.g., steel, brass, aluminum) and/or one or more polymers (e.g., nylon). The inserts may be positioned and retained within the base using conventional rotomolding techniques, which are known in the art and will not be further described herein.

As indicated for insert F in FIG. 2, an insert may have a first end 132, a second end 133, and a center portion 134. An insert may have a dumbbell shape, with a center portion that is narrower in diameter than the first and second ends (e.g., inserts B and C). The first end, the second end, and the center portion may have the same shape or different shapes. Examples of suitable shapes include square, hexagonal, round, oval, and polygonal. Alternatively, the diameter/width of the second end may be greater than the diameters/widths of the first end and the center portion (e.g., inserts A, D, and F). Some inserts may have a center portion of greater width/diameter than the widths/diameters of the first and second ends (e.g., insert E). Other inserts may have two or more first ends and/or center portions coupled to one second end (e.g., insert D). Similarly, an insert may have two or more second ends coupled to a single first end (not shown). Some inserts may be knurled, ridged, or otherwise textured along the center portion (e.g., insert F). In some examples, the second end may include a base plate with one or more cutouts (e.g., insert A).

FIG. 3a illustrates several coupling elements 120 formed on an interior surface 104 of a rotomolded base. FIG. 3b is a closer view of one of the uppermost coupling element 120 shown in FIG. 3a. Coupling elements may be formed in various shapes on interior surface 104. Some coupling elements 120 may have a relatively tapered shape, in which the base 124 has a greater diameter/width than the terminal end 122. Others, such as the coupling element 120 shown in FIG. 3b, may have an undercut shape, in which the terminal end 122 has a greater diameter/width than the base 124.

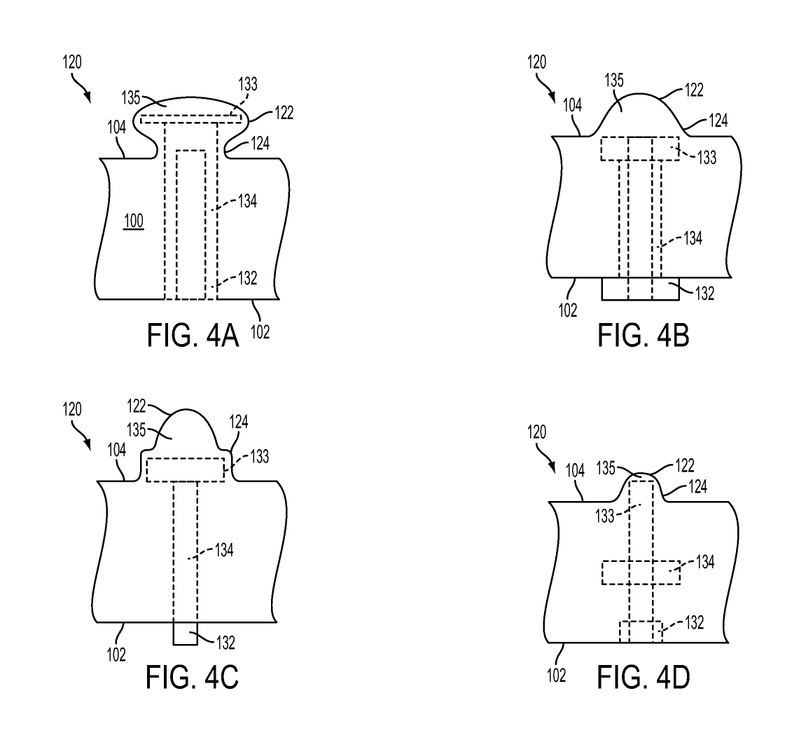

FIG. 4 illustrates four examples of coupling elements 120 (A-D) that may be formed by using inserts of various shapes and configurations. The shape and diameter of the coupling element may be at least partially dependent upon the configuration of the insert. An insert with a second end that is relatively narrow or tapered at the terminus, such as insert E of FIG. 2, may be used to form a coupling element with a relatively tapered shape. Conversely, an insert with a second end that is flared or broader than the central portion may form a coupling element with an undercut shape. The strength of the attachment between the coupling element 120 and an article may depend at least in part on the shape of the coupling element 120. In particular, undercut shapes may provide relatively strong attachments in comparison to tapered shapes. Thus, an insert may be selected based at least in part on the desired configuration of the coupling element 120, the desired strength of attachment to the coupling element(s), and/or parameters of the article to be attached to the coupling element(s). For example, insert F may be selected for molding into a portion of the base where a threaded post is to be attached to the exterior surface of the base, and a relatively strong attachment point is desired on the interior surface of the base.

In addition, the shape and diameter of the coupling element may be at least partially dependent upon the rotomolding process used to form the base. For example, a coupling element may be formed at least in part by positioning the base with the interior surface 104 facing downward before the molten polymer used to form the base solidifies. This may allow the molten polymer to sag or drip downwardly to form the coupling element that includes relatively little (or none) of the insert (see e.g., FIG. 4 B). The cooling temperature and/or duration of cooling time may also be adjusted to produce or enhance the formation of coupling elements.

Articles may be designed in various configurations to engage a coupling element. Articles can be made from one or more plastics/polymers (see e.g. examples of plastics/polymers, above) by any suitable method, including but not limited to a thermoforming process, injection molding, rotomolding, blow molding, transfer molding, reaction injection molding, compression molding, and extrusion molding. Examples include, but are not limited to, polyethylene, thermoform ADS, injection molded polypropylene, thermoform polyethylene, and injection molded nylon. Alternatively, the article can be made from, or include, one or more metals. The article may include a mating portion that is configured to receive and retain the coupling element or some portion thereof.

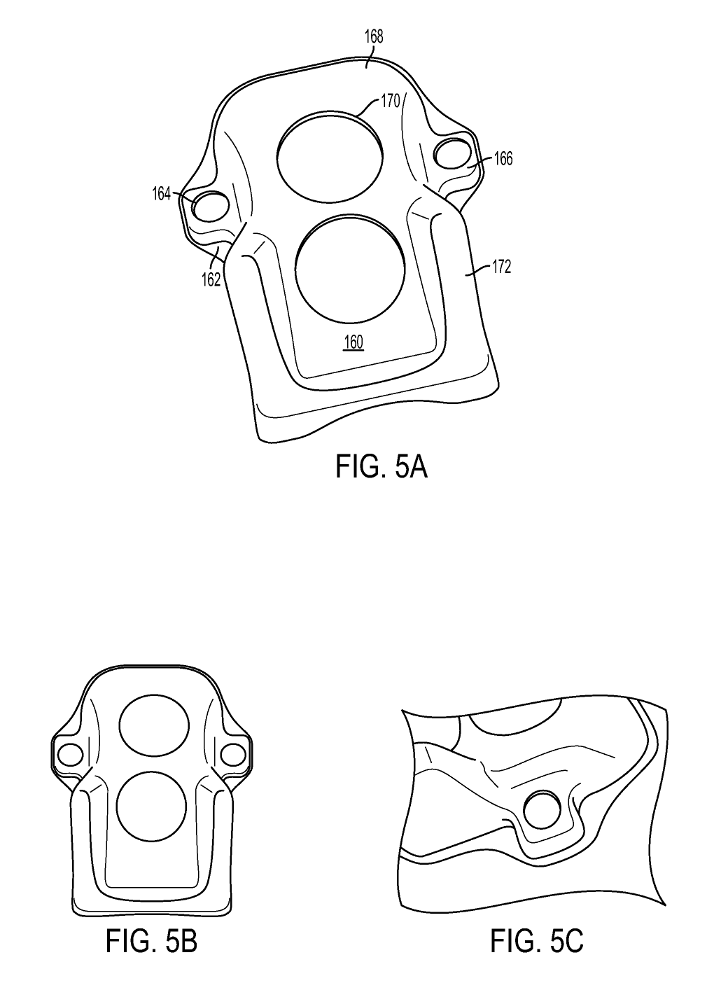

FIGS. 5a-c illustrate an article 160 configured to be coupled to, and retained by, the coupling elements 120 shown in FIG. 1b. In the illustrated example, the article is a thermoformed wall bracket. The article 160 may have one or more mating portions 166, which may include a hole 164 that is configured to receive the terminal end/base of a coupling element. Some articles may have a concavity, a compressible portion, or another feature that is configured to receive the terminal end/base of a coupling element.

The diameter of the holes 164 may be greater than the diameter of base 124 and equal to, or less than, the diameter of terminal end 122. A ridge 162 may extend along one or more portions of article 160. A medial portion 168 may be elevated relative to ridge 162. One or more apertures 170 may extend through the thickness of article 160. Apertures 170 may be provided to decrease the weight of the article, to accommodate a surface feature of another article or item, and/or to allow passage of air or other materials through the article 160. Optionally, article 160 may include one or more surface features 172 that are configured to retain another article or item.

Articles may be designed for use with one or more coupling elements 120 based on one or more parameters including, but not limited to, the diameter of the mating portion(s), the spacing of the mating portions and/or coupling elements (see FIG. 4b), the flexibility of the article or mating portions (e.g., material thickness, natural hinges), and constraining the degrees of freedom to reduce or eliminate the potential for failure. The degrees of freedom are at least partially dependent on load direction (e.g., distribution of forces that will be applied to the article while in engagement with the coupling element) and on other parts, if any, that are retained by the same or other coupling elements and/or that abut, support, or otherwise apply force against the article or item(s) retained by the article.

For example, the article may be a sheet of compressible foam that is to be positioned against one or more other parts (e.g., other foam sheets) that will exert force against the article and help to maintain the article in position. The foam sheet(s) may be inserted to create a bulkhead or portion thereof. The mating portion of the article may be the surface of the foam sheet (i.e., which is configured to compress and form a concavity around a coupling element when pressed against it). Because the load on the article in this example will be relatively minimal and/or broadly distributed, the strength of the coupling required to maintain the article in place is also relatively minimal. Thus, in this example, a relatively flexible mating portion (e.g., the outer surface of the foam sheet) may be sufficient to retain the article against a coupling element that is configured to provide a relatively weak attachment site (e.g., a coupling element with a tapered shape as shown in FIG. 3a).

As another example, the article 160 shown in FIG. 5a may be designed and selected for use with a coupling element that has an undercut shape (e.g., coupling element 120 as shown in FIG. 1b) where the article is intended to bear a relatively heavy bad or a load that is unevenly distributed, is unsupported or less supported by abutting parts, and/or is intended to be more strongly attached to the interior surface of the base. In some examples, the mating portion may have some degree of flexibility that allows the mating portion to flex or distort as the article is attached to the coupling element. This may allow the coupling element to be inserted through a mating portion (e.g., a hole) with a smaller diameter than the terminal end of the coupling element. In some embodiments, the mating portion may be more flexible than one or more other portions of the article (e.g., the mating portion may be thinner than ridge 162 and therefore more flexible). In some examples, articles such as article 160 may be produced by applying a heated plastic to a convex surface (e.g., a male mold) or a concave surface (e.g., a female mold) depending on desired thicknesses of different portions of the article. For example, an article with relatively thinner outer edges may be produced by applying a heated plastic onto a male mold. As the plastic is drawn over the outer surface of the male mold, the outward edges become thinner than the center portion. In contrast, an article with relatively thick outer edges may be formed by applying a heated plastic onto a female mold, with the portions of the plastic that are drawn to the greatest depth within the mold forming the thinnest parts of the article.

Alternatively, an article that is internally threaded (e.g., a female part) may be coupled to a coupling element by screwing the article onto the coupling element. The internal threads may cut threads into the plastic polymer. Such articles may be metal, plastic, or some combination thereof.

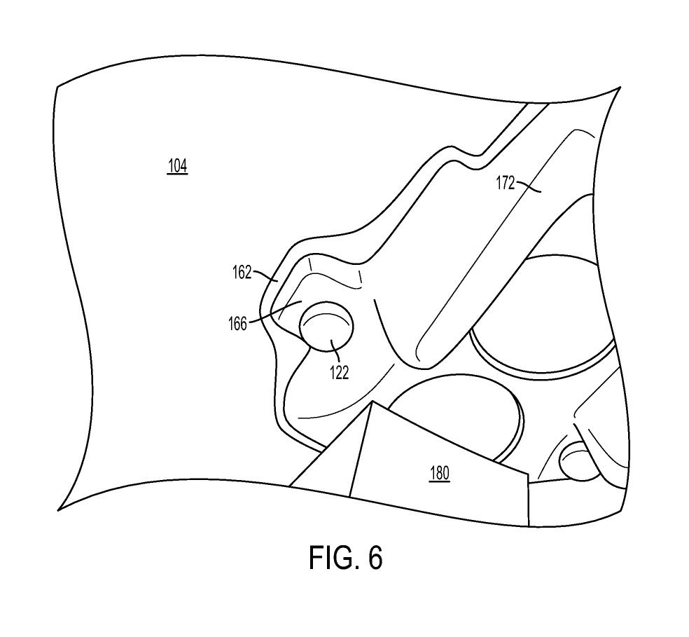

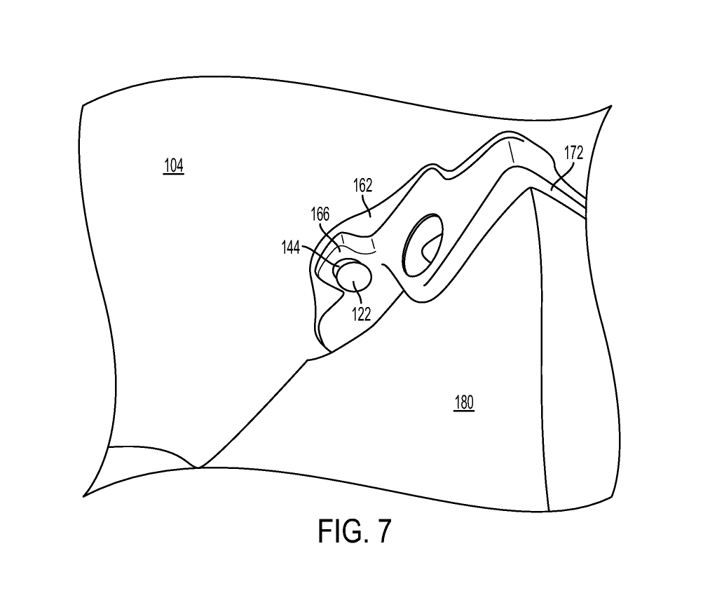

FIGS. 6 and 7 illustrate the article 160 of FIGS. 5a-c coupled to the coupling elements 120 of FIG. 1b. As shown in FIG. 6, the terminal end 122 of the coupling element may be inserted through the hole 164 in mating portion 166. Insertion of the coupling element into hole 164 may require application of force and/or flexing of the article 160. The engagement of the coupling element and mating portion 166 may retain the article against the interior surface of the base. In addition, as best shown in FIG. 7, an additional article 180 may be retained by article 160. In the illustrated example, article 180 is a foam sheet, which is held in place at least partially by surface features 172.

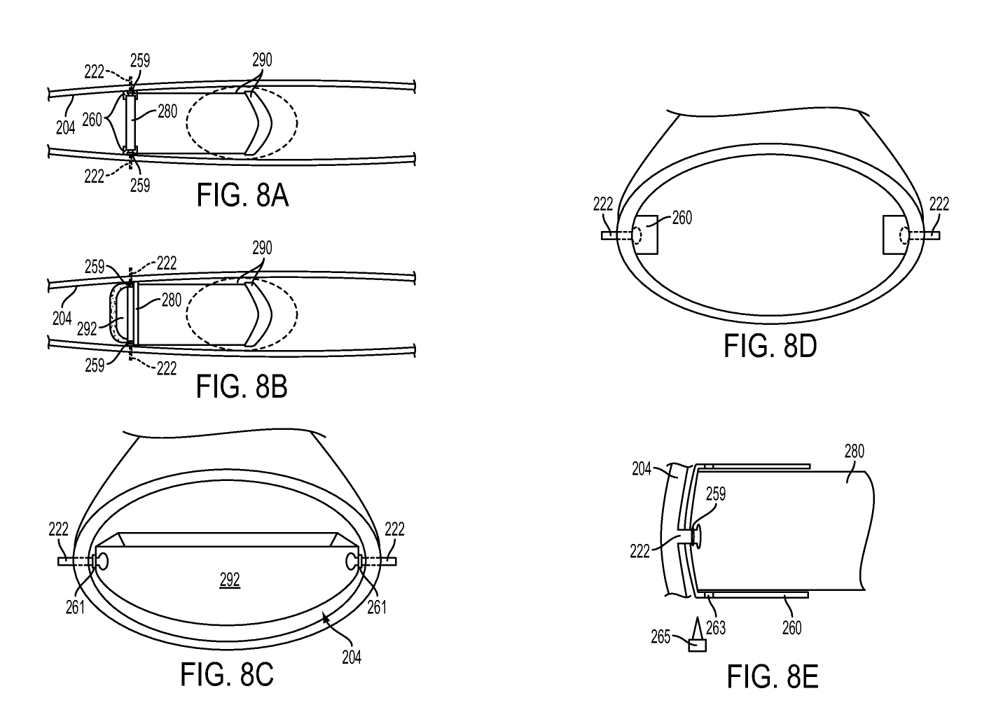

FIGS. 8a-e illustrate examples of articles coupled to a rotomolded base in various configurations by coupling elements. As described above, one or more coupling elements may be formed on an interior and/or exterior surface of a rotomolded base, such the hull of a kayak. A coupling element may be used to retain one, two, three, or more than three articles simultaneously. Similarly, an article retained by a coupling element may be used to retain one, two, three, or more than three additional articles, such as structural components and/or accessories. The configurations and examples of components and accessories of FIGS. 9a-e and the accompanying description are provided merely by way of illustration, and are not intended to be limiting.

FIG. 8a illustrates a plan view of a configuration in which a structural component (bulkhead 280) and an accessory (accessory 290) are fastened to the interior surface 204 of a rotomolded kayak hull by coupling elements 222. FIGS. 8d-e illustrate additional views of this configuration. In this example, accessory 290 is a back band that can be used to support the back of a user seated in the kayak. Accessory 290 can be constructed from one or more pieces of plastic, webbing, and/or fabric. At each end of accessory 290 is an article 259, which includes a mating portion such as a hole or a resilient cap that fits over the end of coupling element 222. For example, article 259 may be a rubber grommet, a plastic ring, or a portion of a resilient deformable material with a hole. Accessory 290 may be fastened to the interior surface 204 of the kayak hull by inserting coupling elements 222 through the corresponding articles 259 as shown.

Coupling elements 222 may also retain articles 260, which may in turn retain bulkhead 280 or another structural component/accessory within the hull of the kayak. Articles 260 may be, for example, U-shaped components as shown in FIG. 8 with a central mating portion such as a hole. Inserting coupling elements 222 through the mating portion of articles 260 fastens articles 260 to the interior surface 204 of the hull. Optionally, as shown in FIG. 8e, an article may have additional holes/mating potions 263 for use in fastening other objects to the article. One or more fasteners 265, such as a pin, nail, screw, strap, tie, or other mechanical fastener, may be inserted through the additional holes/mating portions 263 to enhance the retention of the other object(s). Thus, in FIG. 8e, a fastener 265 may be inserted through an additional hole/mating portion 263 and into bulkhead 280.

Bulkhead 280 may be inserted into articles 260 before or after articles 260 are fastened to the hull. Bulkhead 280 may be a sheet of closed-cell foam or another compressible material, and may deform around the end of coupling elements 222 when retained in position by articles 260. Alternatively, bulkhead 280 may be constructed with one or more voids or concavities to accommodate the ends of coupling elements 222.

Articles 259 and 260 may be placed over coupling element 222 in any order. As shown in FIG. 8a, coupling elements 222 may be placed first through articles 260 and subsequently through articles 259. In some examples, a portion of accessory 290 (e.g., end portions of the material) may be retained between articles 260 and bulkhead 280. Alternatively, coupling elements 222 may be inserted through the mating portions of articles 259 and subsequently through the mating portions of articles 260.

Other accessories or structural components may also be retained by coupling elements, with or without the use of an intermediate article such as articles 260/259. FIG. 8b shows a configuration in which coupling elements 222 are used to retain bulkhead 280, accessory 290, and a second accessory 292. As best shown in FIG. 8c, accessory 292 may be an accessory such as a storage container (e.g., a mesh or fabric bag). One or more articles 261 may be coupled to accessory 292 or to straps/strings extending from accessory 292. Like articles 259, articles 261 may include a ring, grommet, or piece of material with a mating portion such as a hole or a resilient cap that fits over the end of coupling element 222. Accessories 290 and 292 may be fastened to interior surface 204 by inserting coupling element 222 through the corresponding articles 259/261.

As illustrated, a structural component (bulkhead 280) may be retained against interior surface 204 without article 260. For example, bulkhead 280 may comprise a compressible foam sheet with an outer diameter that slightly exceeds the diameter of the space into which it is inserted. Coupling elements 222 may prevent dislocation of bulkhead 280 toward the front of the kayak, and other pressures (e.g., outwardly-directed pressure exerted by the foam, pressure exerted from another component retained by coupling elements 222, and/or the user's feet) may prevent dislocation toward the rear of the kayak. In some examples, coupling elements 222 may be accommodated by one or more cutouts extending at least partially though the thickness of bulkhead 280. In other examples, bulkhead 280 may be provided along an edge or surface with one or more grommets, rings, ties, straps, or other elements that can be used to fasten bulkhead 280 to coupling elements 222.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A method of fastening an article to a molded base having a surface protrusion, the molded base comprising a polymer material with an insert molded therein, the insert having an exposed first portion and a second portion covered by the polymer material, the surface protrusion comprising the second portion of the insert, the method comprising:
providing an article with a mating portion configured to engage the protrusion; and
pressing the mating portion onto the protrusion to couple the article to the molded base.

2. The method of claim 1, wherein the mating portion comprises a hole configured to accommodate at least a portion of the protrusion therein.

3. The method of claim 1, wherein the mating portion comprises a compressible material.

4. The method of claim 1, wherein the exposed first portion of the insert comprises an hollow interior with an opening, the method further comprising coupling a second object to the hollow interior through the opening.

5. The method of claim 4, wherein the hollow interior includes a threaded surface, and wherein the second object has a complementary threaded surface.

6. The method of claim 1, wherein the article further includes one or more surface features configured to accommodate a portion of an object, the method further including coupling the portion of the object to said surface features.

7. The method of claim 1, further including attaching the article to a structural component or an accessory.

8. The method of claim 1, wherein the molded base is a rotomolded component of a watercraft.

9. A fastening system comprising:
a molded base with a surface protrusion, the molded base comprising a polymer material with an insert molded therein, the insert having a first end exposed on a surface of the molded base and a second end covered by the polymer material, the surface protrusion comprising the second end, wherein the surface protrusion has a base portion and a terminal end; and
an article with one or more mating portions configured to engage the protrusion.

10. The fastening system of claim 9, wherein the article includes one or more surface features configured to engage an object to be fastened to the molded base, the system further comprising the object.

11. The fastening system of claim 9, wherein the diameter of the base portion is less than the diameter of the terminal end.

12. The fastening system of claim 9, wherein diameter of the base portion is greater than the diameter of the terminal end.

13. The fastening system of claim 9, the insert having a hollow interior portion with an opening at the second end of the insert.

14. The fastening system of claim 13, wherein the hollow interior portion has a threaded surface.

15. The fastening system of claim 9, wherein the one or more mating portions comprises a hole, wherein the diameter of the hole does not exceed the diameter of the terminal end of the protrusion.

16. The fastening system of claim 9, wherein the one or more mating portions comprises a hole, wherein the diameter of the hole exceeds the diameter of the base portion of the protrusion.

17. The fasting system of claim 10, wherein the object comprises a foam sheet.

18. The fastening system of claim 9, wherein the molded base is a rotomolded kayak deck or hull.

19. A vehicle component comprising:
a molded base with a first surface and a second opposite surface, the molded base comprising a polymer material and an insert with a first end and an opposite second end, the insert molded into the molded base between the first surface and the second surface, the second end covered by the polymer material on the second surface and forming a surface protrusion, the surface protrusion having a base portion and a terminal end, wherein the surface protrusion is configured to engage a complementary mating portion of an article to be attached to the second surface of the molded base.

20. The vehicle component of claim 19, wherein the first end of the insert is configured to provide an attachment site for a first object to be attached to the first surface.

21. The vehicle component of claim 19, wherein the diameter of the terminal end exceeds the diameter of the base portion.

22. The vehicle component of claim 19, wherein the vehicle component is a rotomolded component of a watercraft.

23. The vehicle component of claim 22, wherein the vehicle component is a deck or hull portion of a kayak, and the first surface is an interior surface of the kayak.
